(19) United States
(12) Patent Application Publication
(10) Pub. No.: US 2018/0022483 A1
(43) Pub. Date: Jan. 25, 2018

(54) Bag and Method of Collecting a Material in the Bag

(71) Applicant: Chester LENON, III, Woodbridge, VA (US)

(72) Inventor: Chester LENON, III, Woodbridge, VA (US)

(21) Appl. No.: 15/652,541

(22) Filed: Jul. 18, 2017

Related U.S. Application Data
(60) Provisional application No. 62/364,595, filed on Jul. 20, 2016.

(51) Int. Cl. B65B 7/02; B65F 1/00; B65F 1/14; B65D 33/28

(52) U.S. Cl. CPC B65B 7/02; B65D 33/28; B65F 1/002; B65F 1/14; B65F 2240/138

(57) ABSTRACT

A bag includes an upper surface and a lower surface. When the bag is in use, a material being collected in the bag is placed on the upper surface, and the lower surface is in contact with a support surface. The bag further includes a channel and a drawstring located in the channel. The channel has an opening through which the drawstring is accessible by a user of the bag. The opening is located in a corner of the bag. The bag is cinched closed by pulling on the drawstring.

### CROSS REFERENCE TO RELATED APPLICATIONS

This application claims the benefit of U.S. Provisional Application No. 62/364,595, which was filed on Jul. 20, 2016 and titled “Bag and Method of Collecting a Material in the Bag”. The entire content of this application is incorporated herein by reference.

### BACKGROUND OF THE INVENTION

The present invention pertains to a bag and, more particularly, to a bag that can be converted from a flat or unbundled state to a bundled state.

In certain situations, a person may desire to place a large number of objects into a bag. Typically, the person will simply pick up one or more objects at a time and then place them into the bag through an opening. For example, a person raking leaves will generally rake the leaves into a pile and then stop to place them into a bag by the handful. This two-step process means that the overall duration of the task is increased. In other words, it would be beneficial if the person could rake the leaves directly into the bag. Accordingly, there is a need in the art for a bag that facilitates the filling thereof. More specifically, there is a need in the art for a bag on which yard debris, or other material or objects, can be collected by a user while working such that the collection and filling steps are combined, thereby saving the user time.

Although prior devices have attempted to solve this problem, none of these devices were found to perform as well as the present invention. For example, U.S. Pat. No. 7,976,508 discloses a leaf collection apparatus that is laid flat on the ground such that leaves can be accumulated thereon. An enclosure system allows an operator to enclose the leaves within the apparatus for easier transport. However, the shape of the surface on which the leaves are collected, the exposed nature of the rope and the location of the handle prevent this leaf collection apparatus from performing satisfactorily. Accordingly, there is a need in the art for a bag that meets the requirements set forth above while also addressing such limitations.

### SUMMARY OF THE INVENTION

The present invention is directed to a bag and a method of collecting a material in the bag. The bag includes an upper surface and a lower surface. When the bag is in use, the material being collected is placed on the upper surface, and the lower surface is in contact with a support surface. The bag further includes a channel and a drawstring located in the channel. The channel has an opening through which the drawstring is accessible by a user of the bag. The opening is located in a corner of the bag. The bag is cinched closed by pulling on the drawstring.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1A is a perspective view of a lower surface of a bag constructed in accordance with the present invention, with the bag in a flat or unbundled state;

FIG. 1B is a perspective view of an upper surface of the bag, with material shown on the bag;

FIG. 2A is a perspective view of the bag in a bundled state;

FIG. 2B is a perspective view of the bag cinched closed by a drawstring;

FIG. 3 is a perspective view of a lower surface of a bag constructed in accordance with a second embodiment of the present invention;

FIG. 4 is a perspective view of a lower surface of a bag constructed in accordance with a third embodiment of the present invention;

FIG. 5 is a perspective view of an upper surface of the bag of the third embodiment, with material shown on the bag;

FIG. 6 is a perspective view of the upper surface of the bag of the third embodiment, with a pocket of the bag shown in an expanded state; and

FIG. 7 is a perspective view of the bag of the third embodiment in a bundled state, with the bag cinched closed by a drawstring.

### DETAILED DESCRIPTION OF THE PREFERRED EMBODIMENTS

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention.

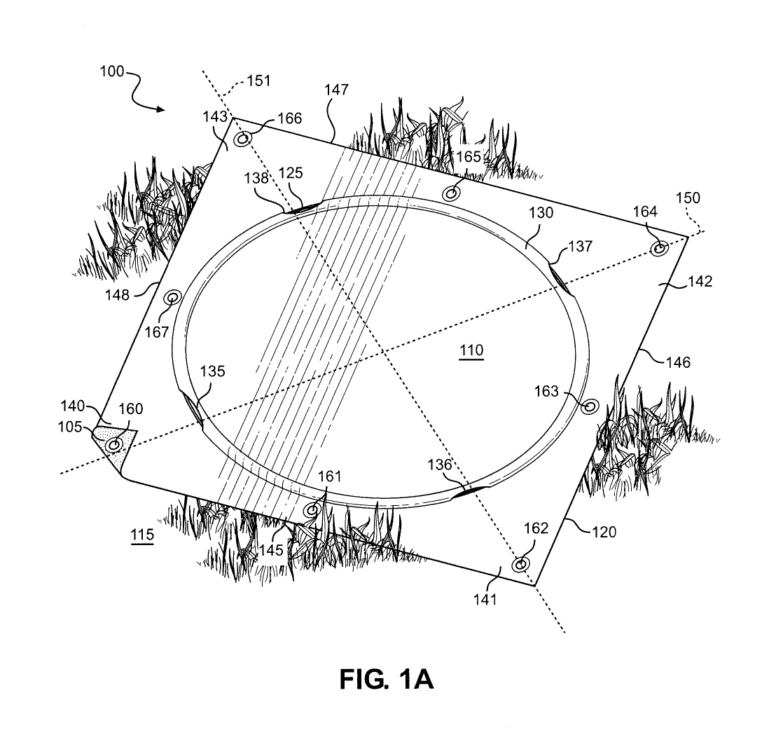

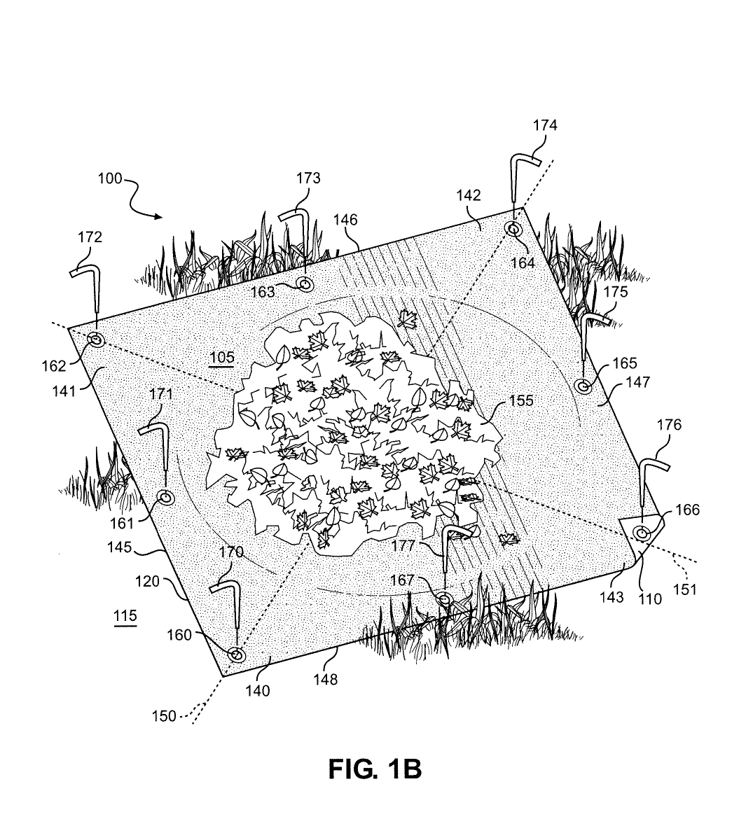

With initial reference to FIG. 1A, there is shown a bag 100 constructed in accordance with the present invention. In particular, bag 100 is shown in a flat or unbundled state. Bag 100 is preferably formed from a plastic material such as low density polyethylene (LDPE), linear low density polyethylene (LLDPE) or high density polyethylene (HDPE). Although a wide variety of materials can be used, the material chosen should preferably be sufficiently flexible so that bag 100 can be folded or bundled and also sufficiently strong so that bag 100 does not break or rip during normal use. While bag 100 can be shaped as a rectangle (or even as some other polygon or as an oval), it has been found that a square shape provides the best results during bundling of the bag (which is described in more detail below). However, it should be recognized that bag 100 need not be perfectly square. For purposes of the present invention, the term “square” is defined as including quadrilaterals where: 1) the length of each side is within 5% of the average side length; and 2) the angle at each vertex is between 85° and 95°. The term “substantially square” is defined as including quadrilaterals where: 1) the length of each side is within 10% of the average side length; and 2) the angle at each vertex is between 80° and 100°. Although the preferred size of bag 100 varies depending on the particular objects or material with which bag 100 is used, the length of each side is preferably between 2 and 8 feet and more preferably between 3 and 6 feet. When bag 100 is used with yard debris, such as leaves, the length of each side is preferably between 4 and 6 feet.

Bag 100 includes an upper surface 105 on which debris is placed, a lower surface 110 that contacts a support surface 115 when bag 100 is in use and an outer edge 120 that defines the shape of bag 100. In FIG. 1A, bag 100 is shown upside down (i.e., with upper surface 105 in contact with support surface 115) to illustrate certain features of the invention. Specifically, bag 100 includes a drawstring or cord 125 located inside a channel 130. Channel 130 has four openings 135-138, one at each of corners 140-143. Drawstring 125 is accessible through openings 135-138 such that a user of bag 100 can grasp drawstring 125 at each of these locations. Drawstring 125 is used to cinch bag 100 closed as described in more detail below. Channel 130 is preferably located relatively near to the perimeter of lower surface 110 to increase the usable area of lower surface 110. In particular, as shown in FIG. 1A, channel 130 is circular and is located proximate to edge 120 at a center of each of sides 145-148. Alternatively, channel 130 can be shaped as a rounded square or squircle such that a greater percentage of channel 130 is located proximate to edge 120. For purposes of the present invention, by a portion of channel 130 being located proximate to edge 120, it is meant that the distance from the portion of the channel 130 to edge 120 is 15% or less of the width of bag 100 at that point. Although channel 130 is illustrated as a single channel having four openings (i.e., openings 135-138), channel 130 can comprise four separate channels spaced by such openings. Channel 130 can be formed in a variety of different ways. For example, a portion of bag 100 can be folded over itself and then sealed or sewn, with channel 130 being located between parallel sealed or sewn areas.

As noted above, openings 135-138 are located in corners 140-143. The location of openings 135-138 is important when bundling bag 100. Specifically, it was found that locating openings 135-138 other than in corners 140-143 does not work well. Accordingly, openings 135-138 are preferably located along imaginary lines 150, 151 corresponding to the diagonals of bag 100 (i.e., the diagonals of the square defined by edge 120). However, it should be recognized that openings 135-138 need not be located exactly on lines 150, 151. Rather, openings 135-138 are considered to be located in corners 140-143 so long openings 135-138 are each within 10° of the nearest line 150, 151, as measured from the center of bag 100.

With reference now to FIG. 1B, bag 100 is shown right-side up with lower surface 110 in contact with support surface 115. For illustration purposes, a pile of material 155 is shown on upper surface 105. As discussed above, material 155 can be yard debris such as leaves, for example. Optionally, bag 100 includes holes 160-167, which are located in each corner 140-143 and in the center of each side 145-148. Holes 160-167 are sized to receive stakes 170-177, which are inserted through holes 160-167 and into support surface 115 to help hold bag 100 in place while material 155 is collected onto bag 100. Although eight holes are shown, it should be recognized that a larger or smaller number of holes can be used.

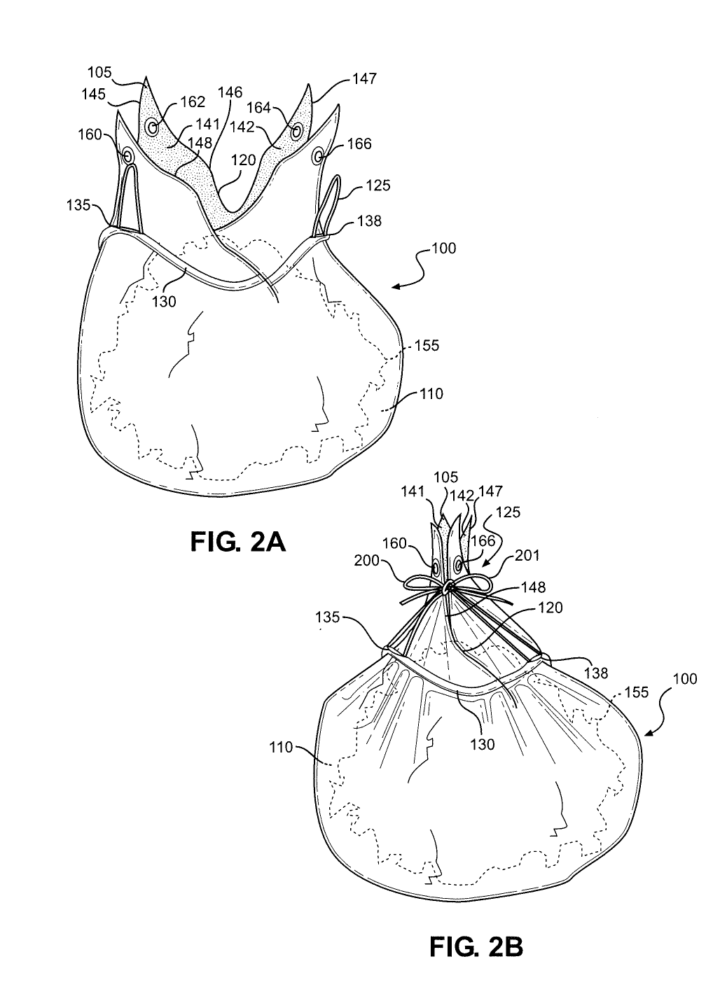

In FIG. 2A, bag 100 is shown in a bundled state. In other words, bag 100 has been folded around material 155 such that corners 140-143 are in contact with one another. Since openings 135-138 are provided on lower surface 110 and located in corners 140-143, drawstring 125 is accessible to a user of bag 100. Accordingly, at this point, the user can grasp drawstring 125 at two opposite locations (e.g., at openings 135 and 137) and pull on drawstring 125 to cinch bag 110 closed in a manner similar to that used with a drawstring trash bag. This cinched state is shown in FIG. 2B. If desired, the user can then tie drawstring 125 to itself in order to help maintain bag 100 in the cinched state. Specifically, the portions of drawstring labeled 200 and 201 can be used to tie a knot. In either case, once bag 100 is cinched, bag 100, and material 155 located therein, can be conveniently transported to another location. Although the above description indicates that the user pulls on drawstring 125 at two opposite locations to cinch bag 100, it should be recognized that the user can instead pull on drawstring 125 at one, three or four of openings 135-138 if desired.

In an alternative approach, the user grasps drawstring 125 prior to bundling bag 100. For example, while bag is in the flat or unbundled state, the user can reach under bag 100 and grasp drawstring 125 at opening 135. The user then grasps drawstring 125 at opening 137 and lifts drawstring 125 upward, thereby raising corners 140 and 142 off of support surface 115, while pulling on drawstring 125. This causes corners 140-143 to move towards one another until bag 100 is cinched with corners 140-143 in contact with one another. As a result, bag 100 is bundled and cinched in one step.

In summary then, bag 100 is typically used as follows. Initially, a user places bag 100 on support surface 115. Optionally, the user inserts stakes 170-177 through holes 160-167 to help hold bag 100 in place. Next, the user places material 155 onto bag 100 (e.g., by raking). Once the user is finished with his or her work or bag 100 is sufficiently full, the user removes stakes 170-177, if necessary, and folds bag 100 over material 155 such that corners 140-143 are placed in contact with one another. The user then cinches bag 100 closed using drawstring 125. If desired, the user can knot drawstring 125 to help keep bag 100 closed and transport bag 100 wherever the user wishes.

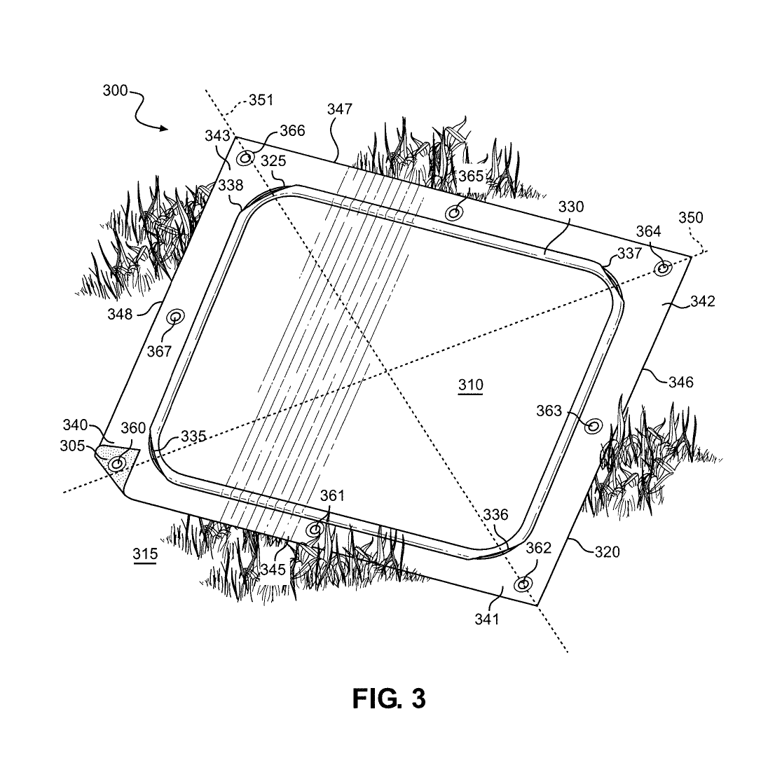

With reference to FIG. 3, there is shown a bag 300 constructed in accordance with a second embodiment of the present invention. Bag 300 is identical to bag 100 except that channel 330 is a rounded square instead of a circle. As a result, more material can be held within bag 300. Since bag 300 is otherwise identical to bag 100, bag 300 will not be described in detail other than to note that the reference numerals of FIG. 3 have been incremented by 200 relative to the reference numerals of FIG. 1A. For example, both 110 and 310 identify a lower surface.

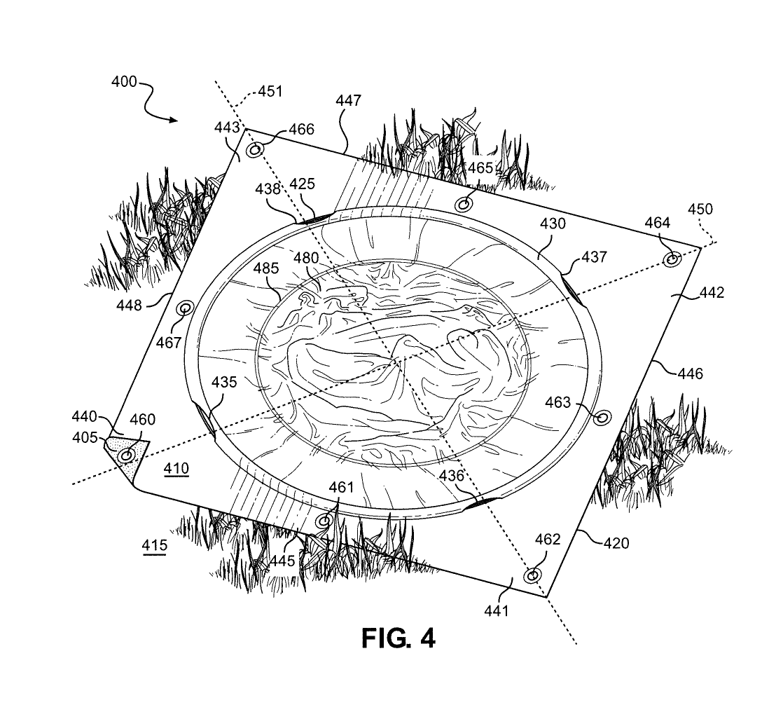

FIG. 4 shows a bag 400 constructed in accordance with a third embodiment of the present invention. Bag 400 is identical to bag 100 except that bag 400 includes a pocket 480 located within channel 430. The inclusion of pocket 480 increases the surface area of bag 400, which allows bag 400 to hold more material. Specifically, the inclusion of pocket 480 means that the surface area of the portion of bag 400 located within channel 430 is greater than the area of the shape defined by channel 430. This is not the case for bag 100. Although pocket 480 is shown spaced inward from channel 430 in FIG. 4, pocket 480 can fill the entire space defined by channel 430. Also, rather than being joined to the remainder of bag 400 by a seam 485, pocket 480 can be formed integrally with bag 400. Since bag 400 is otherwise identical to bag 100, the other features of bag 400 will not be described in detail other than to note that the reference numerals of FIG. 4 have been incremented by 300 relative to the reference numerals of FIG. 1A. For example, both 110 and 410 identify a lower surface.

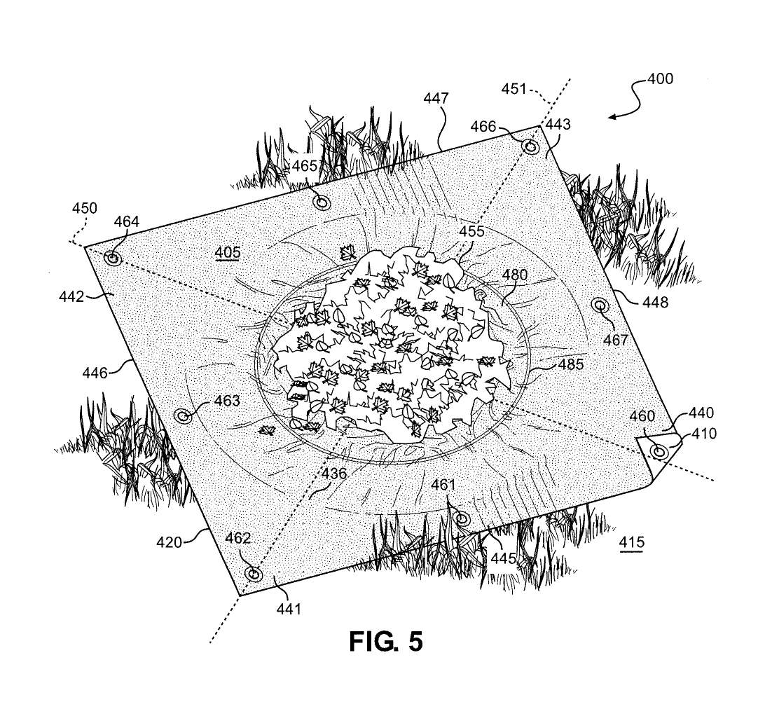

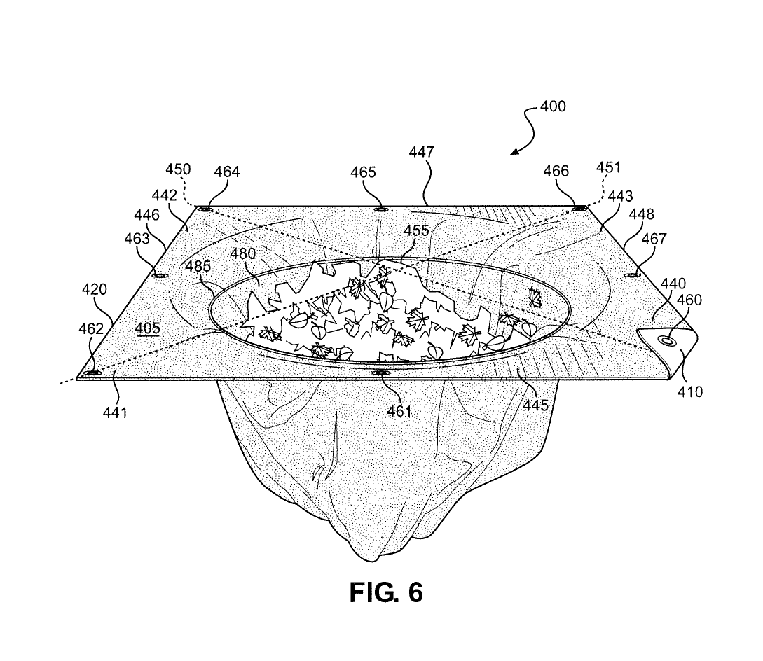

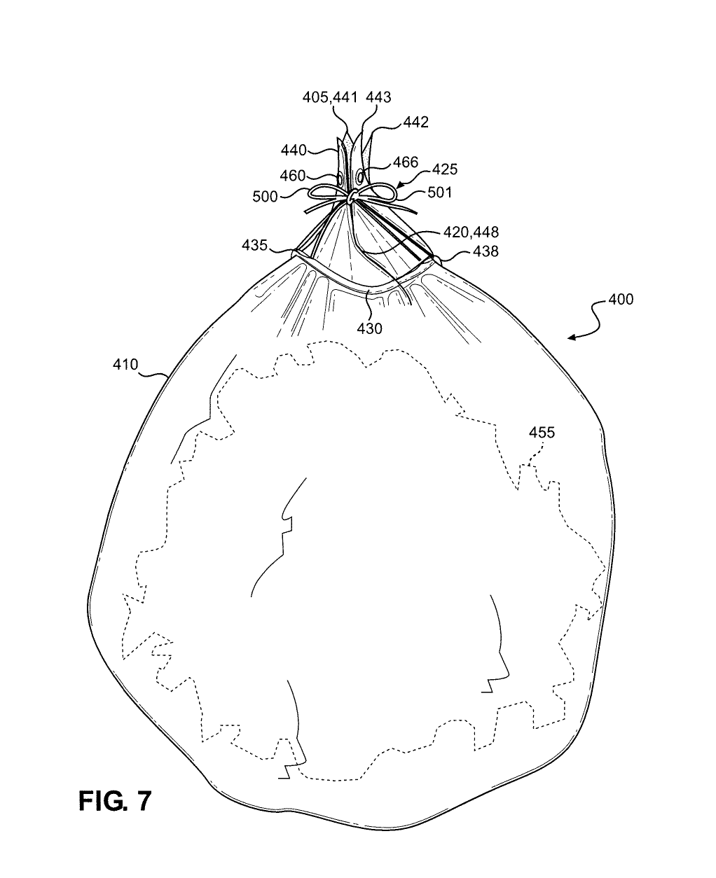

FIG. 5 shows a pile of material 455 located on an upper surface 405 of bag 400. In particular, material 455 is located on pocket 480. When bag 400 is lifted off a support surface 415, pocket 480 expands, as shown in FIG. 6. In this expanded state, pocket 480 extends downward from upper surface 405 such that material 455 is held within pocket 480. In FIG. 7, bag 400 is shown in a cinched state, with portions 500 and 501 of a drawstring 425 used to tie a knot. This allows bag 400, and material 455 located therein, to be conveniently transported to another location.

Based on the above, it should be readily apparent that the present invention provides a bag that facilitates the filling thereof. More specifically, the present invention provides a bag on which yard debris, or other material or objects, can be collected by a user while working such that the collection and filling steps are combined, thereby saving the user time. The bag is an improvement over prior devices in that the drawstring openings are located in the corners, the drawstring is enclosed in a channel and the area delineated by the channel encompasses substantially all of the bag other than the corners. Although described with reference to preferred embodiments, it should be readily understood that various changes or modifications could be made to the invention without departing from the spirit thereof. In general, the invention is only intended to be limited by the scope of the following claims.

1. A bag comprising:
an upper surface, wherein a material being collected in the bag is placed on the upper surface when the bag is in use in a flat state;
a lower surface, wherein the lower surface is in contact with a support surface when the bag is in use in the flat state;
a channel;
a drawstring located in the channel, wherein the channel includes an opening through which the drawstring is accessible by a user of the bag, and wherein the opening is located in a corner of the bag.

2. The bag of claim 1, wherein the bag is convertible between the flat state and a bundled state where the bag is folded around a material being collected in the bag.

3. The bag of claim 1, further comprising an outer edge that defines the shape of the bag, wherein the channel is located proximate to the outer edge at a center of each side of the bag.

4. The bag of claim 1, wherein:
the channel includes a second opening through which the drawstring is accessible by a user of the bag; and
the second opening is located in a second corner of the bag.

5. The bag of claim 1, further comprising a plurality of holes, wherein each of the plurality of holes is sized to receive a stake for holding the bag in place.

6. The bag of claim 1, wherein the bag is substantially square.

7. The bag of claim 6, wherein the channel is shaped as a circle, a rounded square or a squircle.

8. A bag comprising:
an upper surface, wherein a material being collected in the bag is placed on the upper surface when the bag is in use in a flat state;
a lower surface, wherein the lower surface is in contact with a support surface when the bag is in use in the flat state;
a channel defining a shape having an area, wherein the portion of the bag located within the channel has a surface area greater than the area of the shape;
a drawstring located in the channel, wherein the channel includes an opening through which the drawstring is accessible by a user of the bag.

9. The bag of claim 8, wherein the bag is convertible between the flat state and a bundled state where the bag is folded around a material being collected in the bag.

10. The bag of claim 8, further comprising an outer edge that defines the shape of the bag, wherein the channel is located proximate to the outer edge at a center of each side of the bag.

11. The bag of claim 8, wherein the channel includes a second opening through which the drawstring is accessible by a user of the bag.

12. The bag of claim 8, further comprising a plurality of holes, wherein each of the plurality of holes is sized to receive a stake for holding the bag in place.

13. The bag of claim 8, wherein the bag is substantially square.

14. The bag of claim 13, wherein the channel is shaped as a circle, a rounded square or a squircle.

15. A method of collecting a material in a bag, the bag including a channel and a drawstring located in the channel, wherein the channel includes an opening through which the drawstring is accessible by a user of the bag, and wherein the opening is located in a corner of the bag, the method comprising:
placing a lower surface of the bag in contact with a support surface while the bag is in a flat state;
placing the material on an upper surface of the bag while the bag is in the flat state; and
cinching the bag closed by pulling on the drawstring.

16. The method of claim 15, further comprising converting the bag between the flat state and a bundled state by folding the bag around the material.

17. The method of claim 15, wherein the bag further includes a plurality of holes, the method further comprising inserting a stake through each of the plurality of holes and into the support surface to hold the bag in place.
